(19) United States
(12) Patent Application Publication
(10) Pub. No.: US 2013/0059230 A1
(43) Pub. Date: Mar. 7, 2013

(54) CROSS LAMINATED ELECTROCHEMICAL CELL MEMBRANES

(71) Applicants: Tommy Skiba, East Hartford, CT (US); Jesse M. Marzullo, Winsted, CT (US)

(72) Inventors: Tommy Skiba, East Hartford, CT (US); Jesse M. Marzullo, Winsted, CT (US)

(73) Assignee: UTC POWER CORPORATION, South Windsor, CT (US)

(21) Appl. No.: 13/261,510

(22) PCT Filed: May 10, 2010
(86) PCT No.: PCT/US2010/001376

§ 371 Date: Nov. 7, 2012

(51) Int. Cl. H01M 8/10

(52) U.S. Cl. 429/494; 429/479; 429/492

(57) ABSTRACT

A fuel cell proton exchange membrane electrolyte is formed of a first layer (6) having its stronger tensile strength oriented in one direction, laminated to a second layer (7) having its stronger tensile strength oriented perpendicular to the stronger direction of the first layer.

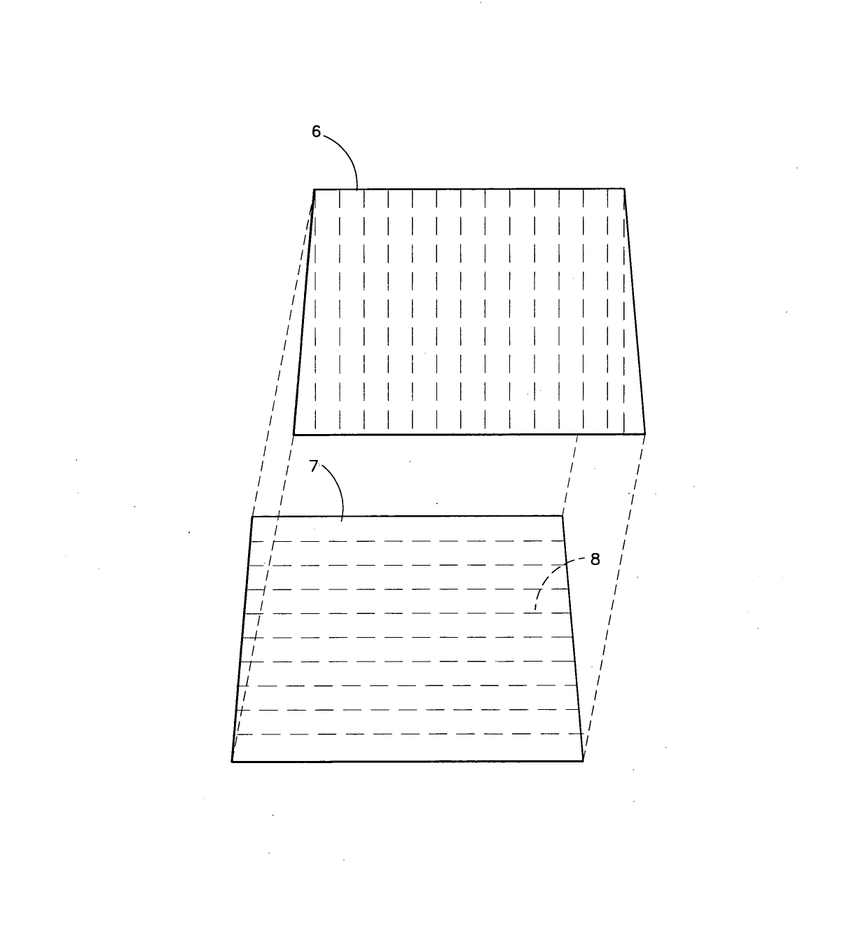

### TECHNICAL FIELD

This invention relates to extending the useful life of fuel cell membranes, such as proton exchange membranes, in fuel cell systems, (useful life) by means of cross lamination that provides physical strength to tolerate strains related to thermal stress and more particularly, water induced stress.

### BACKGROUND ART

A very important characteristic of fuel cell power plants is the reliable lifetime of the fuel cell stack itself. In a fuel cell stack employing proton exchange membranes, the end of useful life of the stack may be caused by failure of the membrane in one or more of the fuel cells.

In fuel cell stacks employing solid flow field plates as separators, as opposed to porous separator plates, the separators do not humidify the reactant streams. However, typical fuel cell stacks operate at various cell current densities so the reaction in the cell produces more or less water. In fuel cells employing solid plates, current density variations cause variations in relative humidity of the reactant streams along the flow path. In turn, the relative humidity of the membrane is increased or decreased, as a function of current generated. Consequently, the membrane either dries out or wets up in response to these changes. Under most fuel cell operating conditions, mechanical durability plays a critical role in determining membrane life and hence the fuel cell stack lifetime. The failure of one or more fuel cells will determine the useful life of a fuel cell stack.

### SUMMARY

A proton exchange membrane, held in place by the immobile edge seal which completely surrounds the membrane, is subject to increases in tensile stresses, particularly in the case where the membrane is drying out (rather than becoming wetter) due to changes in the cell operating conditions. Membranes of the type that are useful in fuel cells are typically anisotropic with respect to mechanical properties: that is, they are weaker in one axis than in another axis as a result of manufacturing. For example, extrusion aligns the polymer fibers such that the membrane is not as resistant to tensile stress in the direction transverse to the extrusion as it is in the direction of extrusion.

To assist in resisting increases in tensile stresses induced in the membrane during fuel cell operation, the membrane is formed of at least two layers, each layer having its stronger direction disposed perpendicular to the stronger direction of the other layer. Each of the layers may comprise a conventional perfluorinated copolymer, which are typically formed by extrusion, causing the direction of stronger resistance to tensile stresses to be in the same direction of the extrusion. However, if the stronger direction is determined otherwise, then, in any case, as long as the at least two layers are brought together with stronger resistance directions perpendicular to each other the additional strength required for extensive membrane life in fuel cells subject to significant changes, especially cells with solid plate reactant flow fields (separators), will be present.

The cross laminated membranes described above will provide fuel cell membranes with the mechanical strength necessary for increasing the longevity of fuel cell power plants, particularly under dry reactant conditions with solid separators. Also, improvements in resisting through-plane mechanical stresses may also be realized with cross lamination described herein.

Other variations will become more apparent in the light of the following detailed description of exemplary embodiments, as illustrated in the accompanying drawings.

### BRIEF DESCRIPTION OF THE DRAWINGS

The sole FIGURE herein is an exploded perspective, pictorial illustration of a cross laminated membrane according to the teachings herein.

### MODE(s) OF IMPLEMENTATION

Referring to the drawing, two layers 6, 7 are shown juxtaposed for being joined into a single cross laminated membrane, the dashed lines 8 therein serving to depict the stronger tensile axis of the respective layers 6, 7. As can be seen, the strong tensile axis of the layer 6 is vertical (as illustrated in the FIGURE), while the strong tensile axis of the layer 7 is horizontal (as seen in the FIGURE).

The two layers may be joined into a single, cross laminated membrane by conventional means: typically, being pressed together in the presence of moderate heat. For instance, the membrane layers may be pressed together for five minutes at 170° C. with an axial load of 250 psi (1723.7 Kpa).

In laboratory bench testing, several sets of two identical NAFION® based membranes were selected. The tensile strength of each in an axis of the direction of extrusion (X axis) and in an axis perpendicular thereto (Y axis) were measured. The average ultimate tensile strength in the X axis of several membranes laminated together with their axes mutually parallel was about 7966 psi (54.9 MPa). The average ultimate tensile strength in the Y axis of several membranes laminated together with their axes mutually parallel was about 6170 psi (43.1 MPa).

When cross laminated (X axis of one membrane perpendicular to X axis of the other membrane), the average ultimate tensile strength of the cross laminated, two layer membrane, in the X axes of one layer, was about 7710 psi (53.2 MPa), and the average ultimate tensile strength, in the axis perpendicular to the X axis of said one layer, was about 7550 psi (52.1 MPa).

Under certain cell configurations and environments, it may be desirable to have additional strength from more layers, in such a case, it is possible to add an additional layer with stronger vertical tensile strength and an additional layer with stronger horizontal tensile strength (related to the drawing). Of course, even more layers may be used whenever it would be beneficial to do so.

Since changes and variations of the disclosed embodiments may be made without departing from the concept's intent it is not intended to limit the disclosure other than as required by the appended claims.

1. An electrochemical cell membrane characterized by:
two proton exchange membrane layers adhered to one another
with one of said layers (6) having its stronger tensile strength oriented in a first direction and another of said layers (7) having its stronger tensile strength oriented in a second direction substantially perpendicular to said first direction.

2. (canceled)

3. A proton exchange membrane according to claim 1 characterized in that:
each of said layers (6, 7) is a NAFION® membrane.

4. A fuel cell power plant comprising:
at least one electrochemical cell proton exchange membrane according to claim 1.

5. A method of forming an electrochemical cell proton exchange membrane, characterized by:
providing two separate proton exchange membrane layers (6, 7) of perfluorinated copolymer, each having its strongest tensile strength along an axis; and
adhering said two layers together into a single electrochemical cell proton exchange membrane, the axis of one of said layers (6) being substantially perpendicular to the axis of the other of said layers (7) after adhering together.

6. The method of claim 5 further characterized in that: said providing step provides two NAFION® membrane layers.
